(19) United States
(12) Patent Application Publication
(10) Pub. No.: US 2026/0322223 A1
(43) Pub. Date: Oct. 15, 2026

(54) Comb Device, For Receiving Hairpins To Be Subsequently Transferred Into The Slots Of A Motor Stator, And Method Of Use

(71) Applicant: Comau (Shanghai) Engineering Co., Ltd., Shanghai (CN)

(72) Inventors: Yunhui Gao, Shanghai (CN); Lei Suo, Shanghai (CN)

(73) Assignee: Comau (Shanghai) Engineering Co., Ltd., Shanghai (CN)

(21) Appl. No.: 19/486,071

(22) PCT Filed: May 17, 2024
(86) PCT No.: PCT/CN2024/093916

§ 371 Date: Nov. 20, 2025

(30) Foreign Application Priority Data
May 22, 2023 (CN) 202310579813.X

(51) Int. Cl. H02K 15/0643; H02K 15/085

(52) U.S. Cl. CPC H02K 15/0643; H02K 15/085; H02K 2215/00

(57) ABSTRACT

A comb device, for receiving a group of hairpins to be subsequently transferred into the slots of a motor stator, includes a cylindrical comb core with a circumferential array of uniformly distributed axial slots into which a plurality of hairpins can be inserted. A driving mechanism simultaneously drives a circumferential array of clamp elements in a radial movement to clamp the hairpins positioned in the comb core. Once all the hairpins have been positioned in the comb core, an upper lifting plate is raised to move the hairpins to a position projecting further upwardly from the comb core. The upper lifting plate is then returned to its start position while the clamp elements clamp the hairpins so that the hairpins remain in the position projecting upwardly from the comb core in which the group of the hairpins can be picked-up and separated as a whole from the comb core.

### CROSS-REFERENCE TO RELATED APPLICATIONS

This application is filed pursuant to 35 U.S.C. § 371 claiming priority benefit to PCT/CN2024/093916 filed May 17, 2024, which claims priority benefit to China Patent Application No. 202310579813.X filed May 22, 2023, the contents of both applications are incorporated herein by reference in their entirety for all purposes.

### TECHNICAL FIELD

The present invention generally refers to systems and methods for the manufacture of motor stators and relates in particular to a comb device for receiving a group of hairpins to be subsequently transferred into the slot of a motor stator.

### BACKGROUND

According to a conventional technique, during manufacture of a motor stator, the stator windings are obtained by providing flat wires in the form of hairpins which are manually plugged into the slots of the stator core. Due to the large number and variety of the hairpins, when workers repeatedly perform this operation, it is inevitable that they can be distracted and misplace the hairpins, thus causing errors in the positions of the stator windings. As a result, the motor stator cannot be used and needs to be reworked, greatly reducing the production efficiency.

Various solutions have been proposed for automatically performing the operation of inserting the hairpins into the slots of a motor stator, all of which however have proved to be not completely satisfactory.

In document EP 3 868 006 B1, on which the preamble of claim 1 is based, a method for manufacturing a motor stator has been proposed, in which a stator core template is provided. The hairpins are inserted into slots of the template to form a complete nest of hairpins which are subsequently transferred into the slots of a “real” stator core. During insertion of the hairpins into the slots of the template, groups of hairpins are inserted in a first position within the slots and then are radially inwardly moved by pushers towards their final intended position. However, in this solution the above-mentioned pushers engage the portions of the hairpins projecting outwardly from the template, which might result in undesired deformations of the hairpins.

Therefore, there is still a need of a fully satisfactory solution in this field.

### SUMMARY

The object of the present invention is that of solving the above-mentioned problem, by enabling the manufacture of a motor stator to be performed automatically, with a high production efficiency and yet ensuring high precision and quality.

In view of achieving the above-mentioned object, the invention is directed to a comb device, for receiving a group of hairpins to be subsequently transferred into the slots of a motor stator, said comb device comprising a cylindrical comb core having a cylindrical lateral surface and two opposite end surfaces and a circumferential array of uniformly distributed axial slots which open at their two opposite ends on the two opposite end surfaces of the comb core, said slots being configured for receiving therein a plurality of hairpins,
said comb device being characterized in that said axial slots of the comb core also open radially outwardly on apertures of the lateral surface of the comb core, and in that said comb device further comprises:
a circumferential array of clamp elements radially slidably mounted within said slots of the comb core through said apertures on the lateral surface of the comb core, said clamp elements being configured for clamping the hairpins within said slots after that all the hairpins have been positioned within said slots, and
a driving mechanism for simultaneously driving a radial movement of all the clamp elements within the respective slots of the comb core.

In a preferred embodiment, said driving mechanism for simultaneously driving a radial movement of all the clamp elements includes:
a circumferential array of radial driving members, surrounding the array of clamp elements, outside the comb core, each driving member being operatively connected to a respective one of said clamp elements, said driving members being radially slidably guided within radial guiding passages of a stationary annular plate,
a driving annular plate, surrounding the comb core and rotatably mounted around a main axis of the comb core on said stationary annular plate,
said driving annular plate having a plurality of spiral slits engaged by cam-followers which are carried by said driving members, said spiral slits being configured so that a rotation of said driving annular plate between two end positions causes a radial movement of said driving members, and hence of said clamp elements, between two end positions, and
an actuator for rotating said driving annular plate between said two end positions.

In the preferred embodiment, said spiral slits are configured so that a rotation of the driving annular plate at a constant speed causes a radial movement of the clamp elements at a constant speed.

Furthermore, in the preferred embodiment, each spiral slit is engaged by two cam-followers carried by two driving members which are adjacent to each other, so that the number of spiral slits is half the number of the clamp elements.

According to a further preferred feature, each driving member is a rod-like member having one end hinged to the respective clamp element and the opposite end carrying a respective cam-follower.

According to a further preferred feature, the comb device includes an upper lifting plate arranged above the upper end surface of the comb core and having a circumferential array of slots which correspond in number and positions with the slots of the comb core, so that when hairpins are being axially plugged into the slots of the comb core, the hairpins first engage the slots of said upper lifting plate and then the slots of the comb core. The upper lifting plate is connected to an actuator which is operable for:
once all the hairpins have been positioned into the comb core, raising said upper lifting plate from a position adjacent the comb core to a raised position, spaced apart upwardly from the comb core, in which the upper lifting plate causes the hairpins to project further upwardly from the upper end surface of the comb core, and
subsequently returning the upper lifting plate to its start position adjacent the comb core, after that the clamp elements have been driven to clamp the hairpins within the comb core, so that the hairpins remain in said position projecting upwardly from the comb core in which the group of the hairpins can be picked-up and separated as a whole from the comb core.

According to a further feature, during insertion of the hairpins into the comb core, said driving mechanism is operable for progressively moving the clamp elements radially outwardly while hairpins are being inserted into the slots of the comb core, so as to progressively leave more radial space within the slots for the hairpins to be positioned within the slots.

The invention is also directed to a method for obtaining a group of hairpins (H) to be transferred into the slots of a motor stator as implemented by means of the above-described comb device.

### BRIEF DESCRIPTION OF THE DRAWINGS

FIG. 1 is a perspective view of the system including a comb device according to the invention and a robot for plugging hairpins into the comb device;

FIG. 2 is a perspective view of the comb device of FIG. 1, with a covering plate removed;

FIG. 3 is a perspective view of a stationary annular plate with a circumferential array of guiding passages having a T-shaped cross-section;

FIG. 4 is a perspective view of the comb core with a group of hairpins inserted therein, also showing two clamp elements slidable within slots of the comb core, with two driving members connected to the clamp elements;

FIG. 5 is a perspective view of a driving annular plate which is part of the driving mechanism for causing radial movement of the clamp elements within the slots of the comb core;

FIG. 6 is a perspective view from below, showing the system for actuating the vertical movement of the upper lifting plate of the comb device of the invention;

FIG. 7 is a cross-sectional view in a vertical plane of the unit of FIG. 6;

FIG. 8 is perspective view of the comb core forming part of the comb device according to the invention;

FIG. 9 is a detail at an enlarged scale of a single clamp element with the associated driving member;

FIG. 10 is a perspective view of the stationary annular plate of FIG. 3, showing also the driving members which are slidably guided within the guiding passages of the plate;

FIG. 11 is a partial perspective view of the comb device, with the covering plate removed;

FIG. 12 shows a detail of the annular driving plate, at an enlarged scale;

FIG. 13 is a perspective view of the upper portion of the comb device, with a group of hairpins inserted therein;

FIGS. 13A-13D show different stages of the process for inserting the hairpins; and

FIGS. 14-16 show three different stages of the operation for bringing the entire group of hairpins, after insertion thereof, to a position projecting further upwardly from the comb device of the invention.

### DETAILED DESCRIPTION

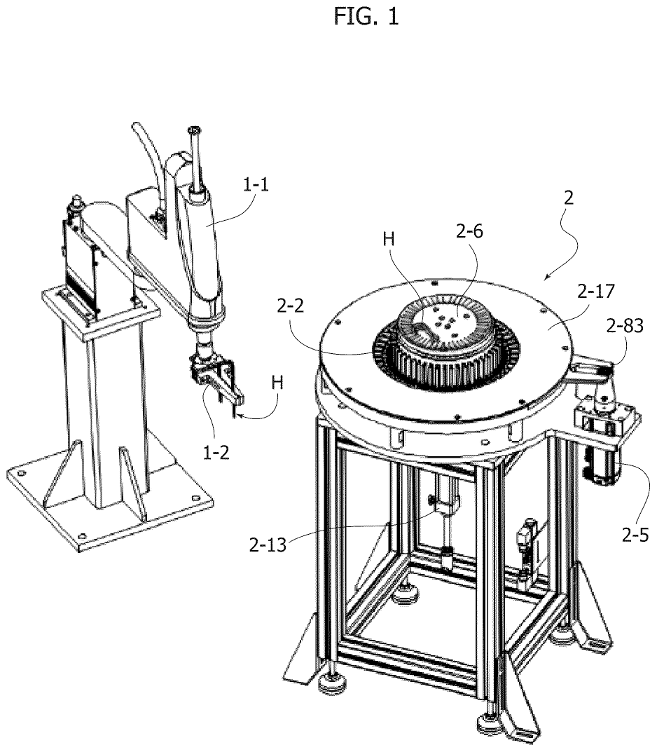

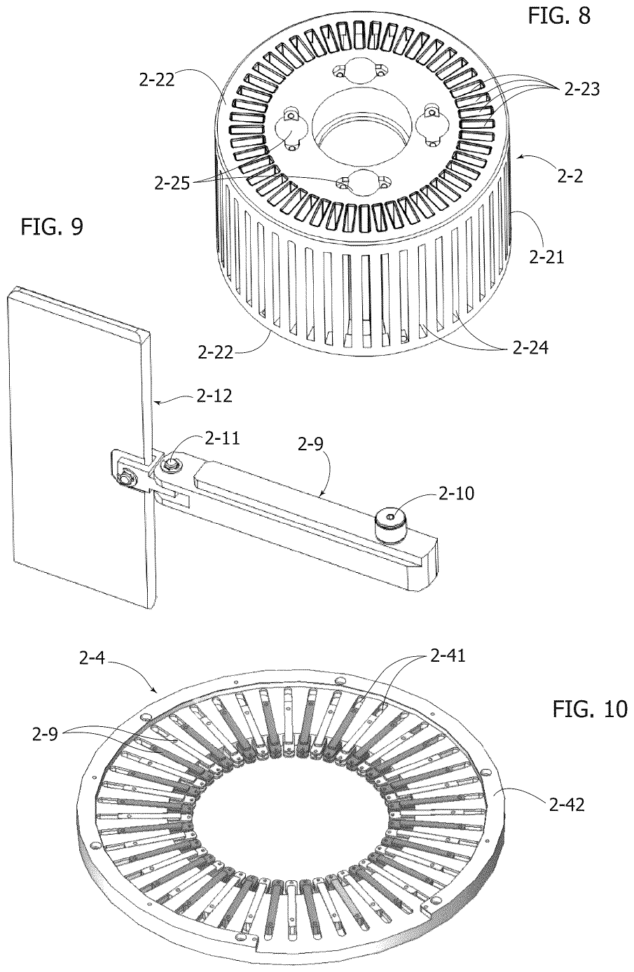

In FIG. 1, reference numeral 2 generally designates an example of a comb device according to the present invention. The comb device 2 includes a cylindrical comb core 2-2, better shown in FIG. 8, having slots 2-23 for receiving a group of hairpins H.

FIG. 1 shows one hairpin H carried by a gripper 1-2 of a robot 1-1, which is used for automatically plugging the hairpins H into the slots 2-23 (FIG. 8) of the comb core 2-2 of the comb device 2. The comb device of the invention is used to enable a complete group of hairpins to be automatically plugged into the slots of a comb core, after which the complete group of hairpins can be transferred from the comb core into the slots of a motor stator.

As shown in detail in FIG. 8, the cylindrical comb core 2-2 has a cylindrical lateral surface 2-21, and two opposite end surfaces 2-22. The comb core 2-2 has a circumferential array of uniformly distributed axial slots 2-23 which extend axially from one end surface 2-22 to the other, so that the slots open at the two opposite ends of the comb core 2-2.

The slots 2-23 also open radially outwardly, on apertures 2-24 of the outer surface 2-21 of the comb core.

Reverting to FIG. 1, each hairpin has a general U-shape configuration, with two legs and an upper bridge portion. The hairpins H are plugged into the slots 2-23 of the comb core 2-2 with their legs oriented downwardly.

In a preferred embodiment, the hairpins H are of a type defined by a wire having a flat, non-circular cross-section.

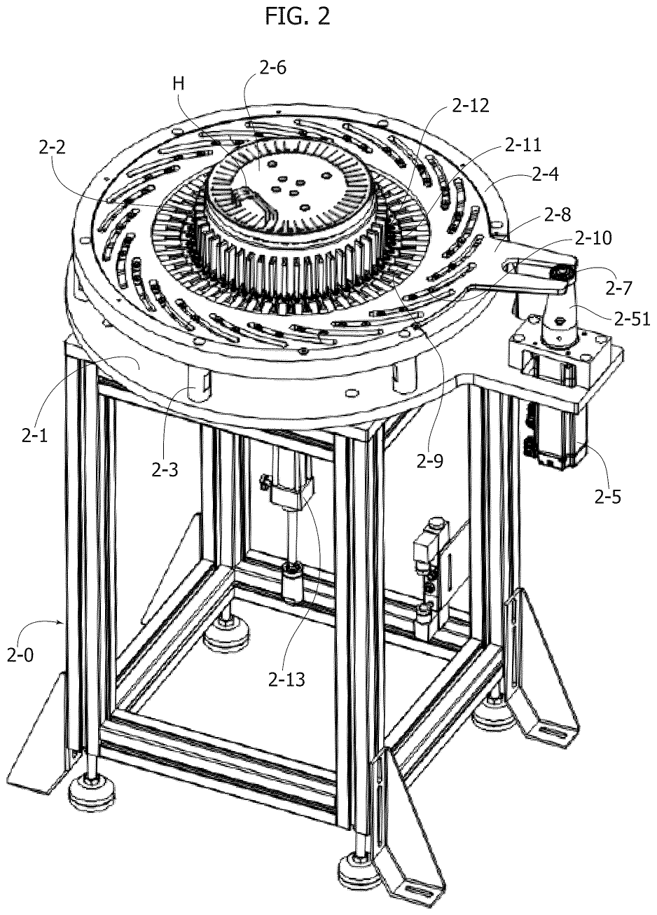

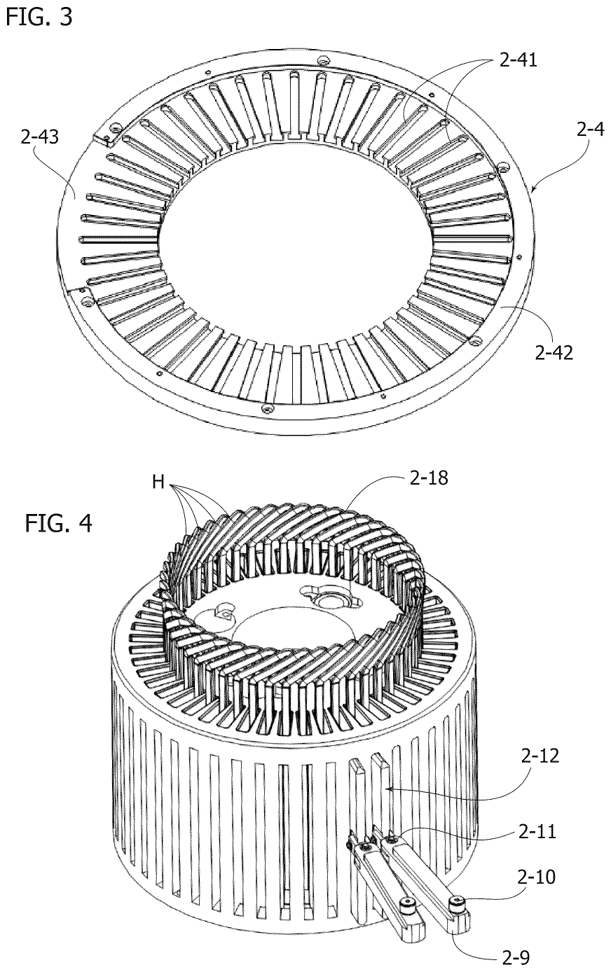

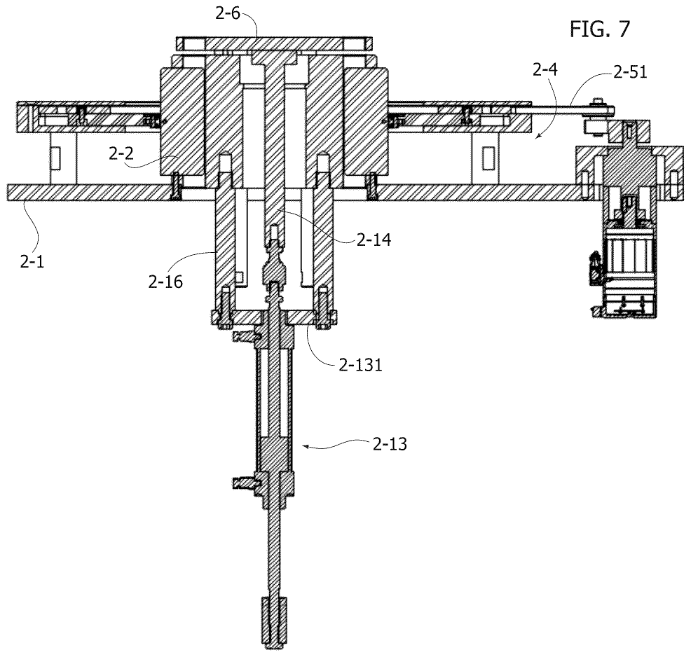

Referring to FIG. 2, the example of the comb device 2 illustrated therein includes a stationary frame 2-0 carrying a stationary plate 2-1 on which the comb core 2-2 is locked in position (see also FIG. 7) by any known means. This stationary plate 2-1 carries, by means of a number of supports 2-3, an annular stationary plate 2-4, better shown in FIGS. 3 and 10, which surrounds the comb core 2-2.

The comb device 2 of the invention further includes a circumferential array of clamp elements 2-12 radially slidably mounted within the slots 2-23 of the comb core 2-2, through the apertures 2-24 of the lateral surface 2-21 of the comb core. In the illustrated example, the comb core has 48 slots 2-23, so that 48 clamp elements 2-12 are provided, each clamp element 2-12 being slidable radially within a respective slot 2-23 through to the openings 2-24.

FIG. 9 of the drawings shows, at an enlarged scale, the detail of a single clamp element 2-12. Each slot 2-23 of the comb core 2-2 (FIG. 8) is formed with a rectangular cross-section, defined by two parallel side surfaces. Correspondingly, each clamp element 2-12 is in form of a vertical plate, slidably mounted between the two-side surfaces of each slot 2-23, the vertical dimension of each clamp element 2-12 being lower than the vertical dimension of the openings 2-24 of the slots 2-23 on the lateral surface 2-21 of the comb core 2-2.

As shown in greater detail in FIG. 9, each clamp element 2-12 is driven by a driving mechanism including a driving member 2-9 in the form of a rod-like member with an inverted T-shaped cross-section.

Each driving rod member 2-9 has one end hinged to the respective clamp element 2-12 at 2-11, around a vertical axis, and has the opposite end carrying a cam-follower 2-10 in form of a freely rotatable roller, whose function will become clear in the following.

The driving rod members 2-9, associated with the clamp elements 2-12, are radially guided within the radial guiding passages 2-41 of the stationary annular plate 2-4 (see FIGS. 3, 10). The driving mechanism is configured for simultaneously driving a radial movement of all the clamp elements within the respective slots of the comb core.

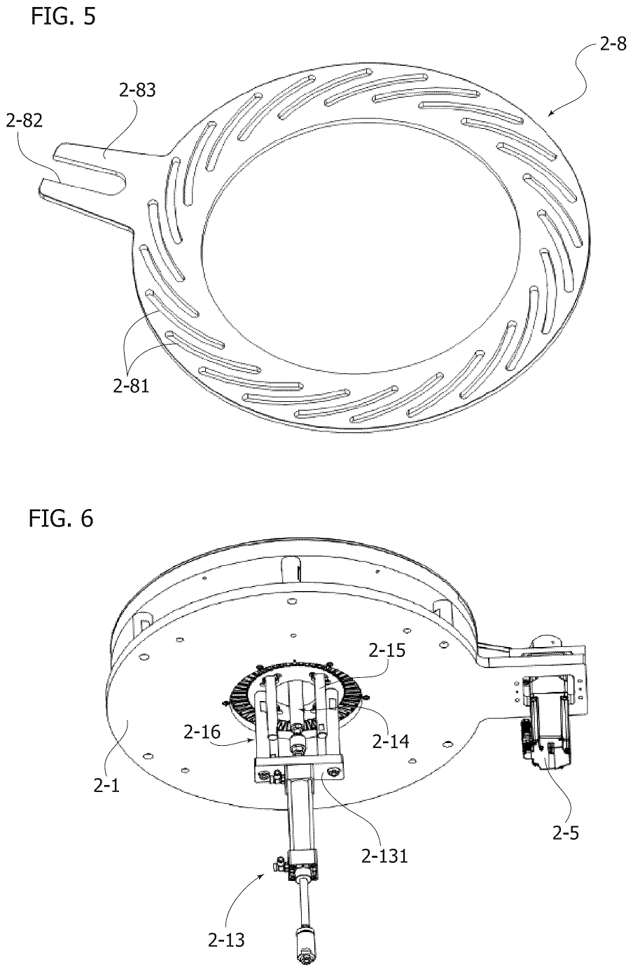

In the illustrated example, the stationary annular plate 2-4 has a projecting peripheral edge for rotatably supporting an annular driving plate 2-8 (see FIG. 5) above the stationary annular plate 2-4.

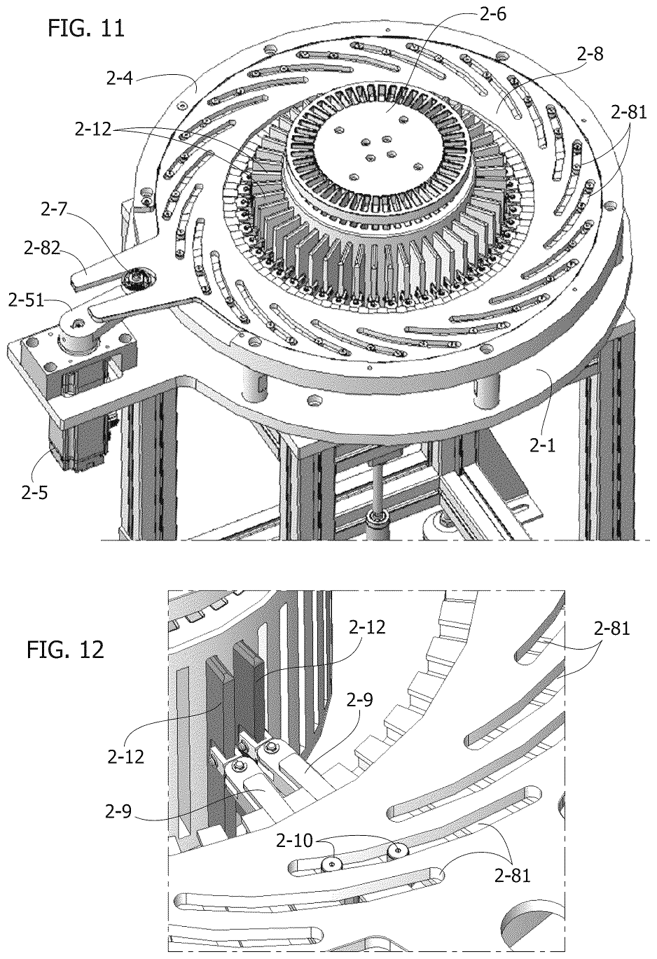

As shown in FIGS. 11, 12, the driving annular plate 2-8 has a plurality of spiral slits 2-81 engaged by respective cam-followers 2-10 carried by respective driving members 2-9.

In the illustrated example, each spiral slit 2-81 is engaged by two cam-followers 2-10 carried by two adjacent driving members 2-9 which are operatively connected to two respective clamp elements 2-12.

The spiral slits 2-81 are configured in such a way that a rotation about a main axis of the comb core of the driving plate 2-8 between two end positions thereby causing a radial movement of each clamp element 2-12 between two end positions. Most preferably, the spiral-slit 2-81 are so configured that a rotation of the driving plate 2-8 at a constant speed causes a radial movement of the clamp elements 2-12 at a constant speed.

As indicated, each spiral-slit 2-81 is engaged by two cam-followers 2-10. Therefore, the number of spiral slits 2-81 is half the number of the clamp elements 2-12. Therefore, for a comb core having 48 slots, 48 clamp elements 2-12 are provided, while only 24 spiral slits 2-81 are provided in the driving plate 2-8. Due to the above indicated arrangement, the two driving members 2-9 carrying the cam-followers 2-10 which are engaged within a same spiral-slit 2-81 have a different length.

As it will be understood, the above indicated preferred configuration enables the driving plate 2-8 to be made with a simpler configuration.

In the illustrated example, rotation of the annular driving plate 2-8 is controlled by a motor 2-5 carried by the stationary base plate 2-1. Motor 2-5 controls the rotation of a crank 2-51, carrying a roller 2-7 engaged within a slot 2-82 of a radial extension 2-83 of the driving annular plate 2-8.

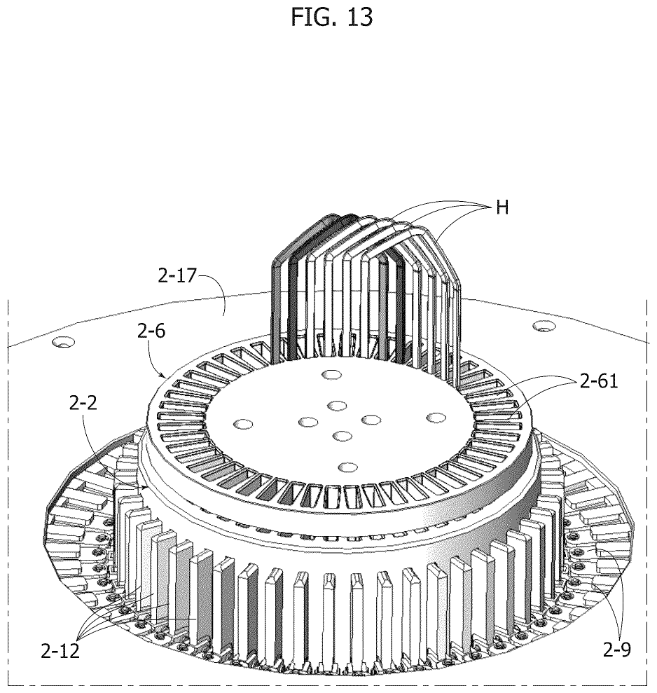

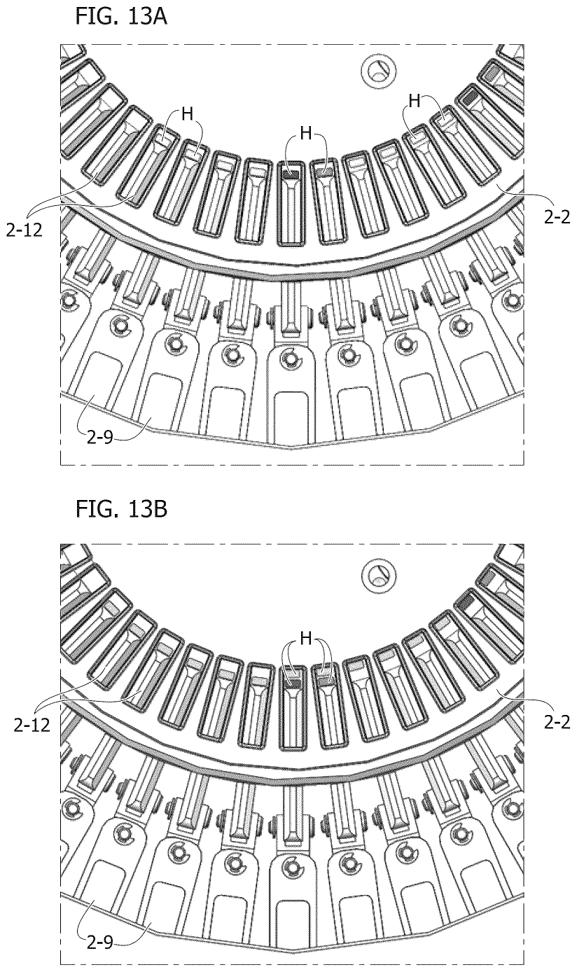

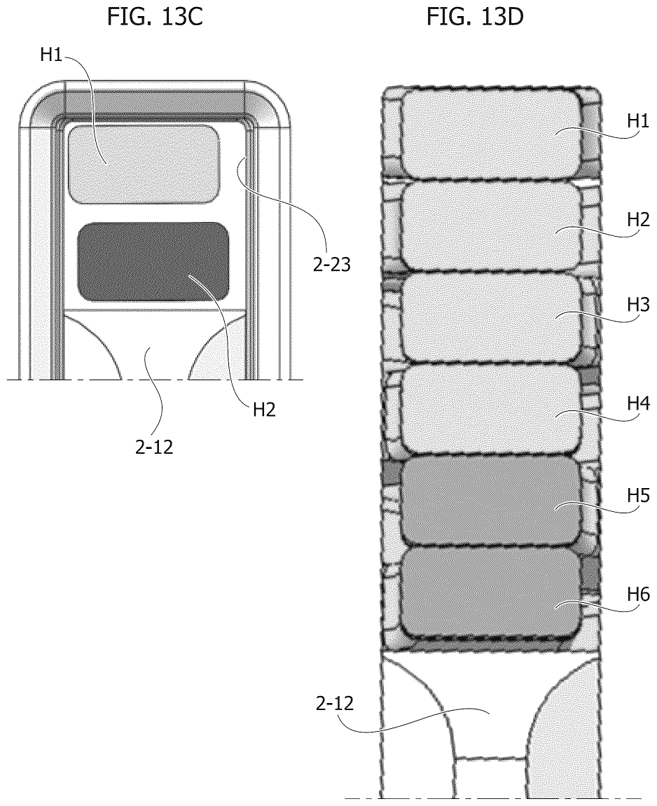

In the illustrated example, the comb device 2 of the invention further includes an upper lifting plate 2-6, arranged above the upper end surface of the comb core 2-2 and having a circumferential array of radial slots 2-61 (FIG. 13) corresponding in number and positions with the slots 2-23 of the comb core 2-2, so that when the hairpins H are axially plugged into the slots 2-23 of the comb core 2-2, they first engage from above the radial slots 2-61 of the upper lifting plate 2-6 and then the slots 2-23 of the comb core 2-2.

The upper lifting plate 2-6 is operatively connected to the stem 2-14 of a cylinder 2-13. With reference to the FIGS. 6-7, the cylinder 2-13 is arranged vertically below the stationary plate 2-1, along the axis of the comb core 2-2. The body of cylinder 2-13 is carried by a plate 2-131 which is supported by connecting rods 2-16 secured to the lower end surface of comb core 2-2. The cylinder 2-13 has a stem 2-14, having an upper end connected to the central portion of the lifting upper plate 2-6. In addition, the upper plate 2-6 is connected to guiding rods 2-15 (FIG. 6) which are slidably guided through passages 2-25 (FIG. 8) of the comb core 2-2.

With reference to FIG. 1, a dustproof covering plate 2-17 is secured on the upper peripheral edge 2-42 of the stationary plate 2-4. The peripheral edge 2-42 is interrupted at a portion 2-43 (FIG. 3) so as to leave space for the radial extension 2-83 of the driving plate 2-8.

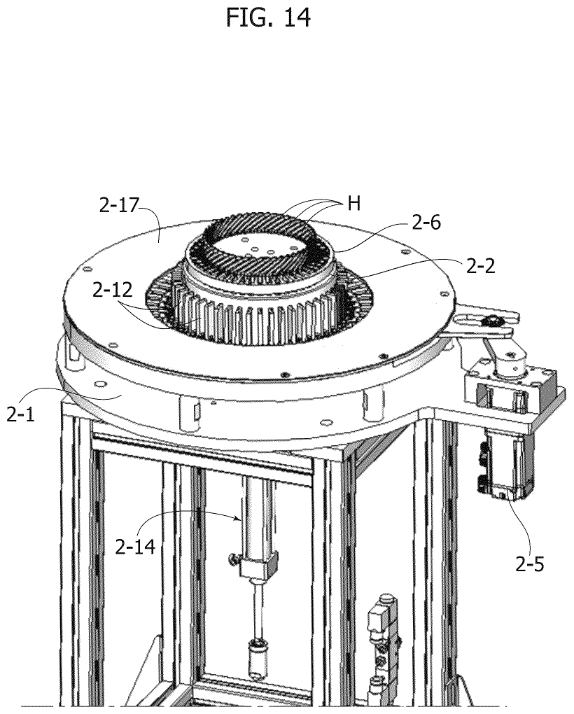

In operation, during the stage in which the hairpins H are plugged through slots 2-61 of the upper plate 2-6 and through the slots 2-23 of the comb core 2-2, the upper plate 2-6 is in the lower position shown in FIG. 14, adjacent to the upper end surface of the comb core 2-2.

FIGS. 13A-13D show different stages of the hairpin insertion process. FIG. 13A shows an initial stage in which a first set of hairpins H have been inserted into slots, with the clamp elements 2-12 being arranged in a radially innermost position. After the insertion of this first set of hairpins, the clamp elements 2-12 are slightly moved radially outwardly to leave a radial space (e.g., more space) along a radial direction within each slot slightly greater that the radial dimensions of two wires (see FIGS. 13B, 13C) so that a second wire H2 can be

introduced radially outside a first wire H1 which has been previously inserted. The clamp elements are then progressively moved radially outwardly, to enable a total of six wires (in this example) H1, H2, H3. H4, H5 and H6 to be received within each slot (see FIG. 13D).

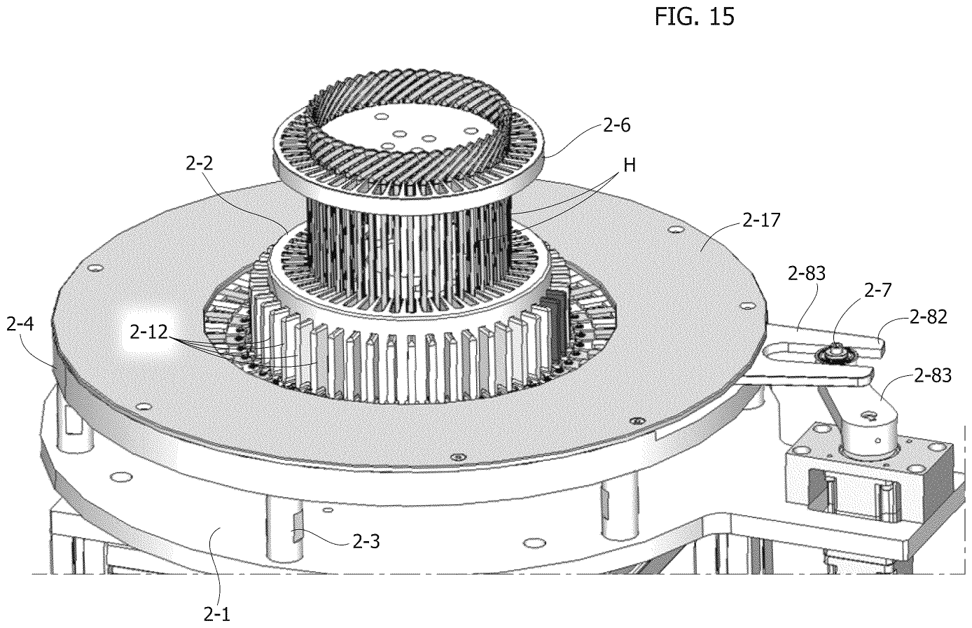

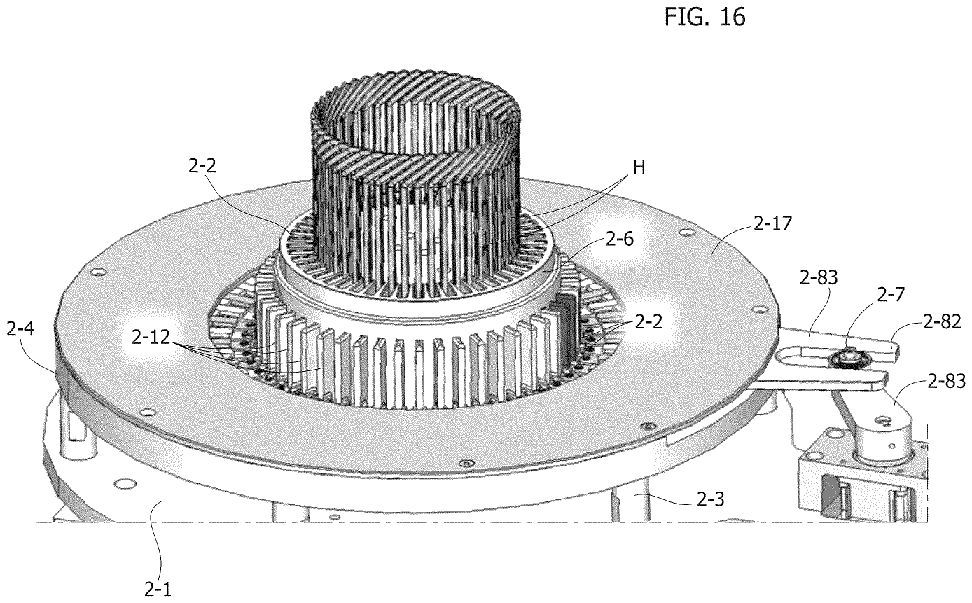

When (i.e., once) all the hairpins have been plugged into, they are first pressed downwardly by a pressing plate (not shown in the drawings) to ensure that all the upper ends of the hairpins are at the same level. At this stage, the upper lifting plate 2-6 is brought from the lowered position (e.g., start position) of FIG. 14 to a raised position (e.g., spaced apart upwardly from the comb core) as shown in FIG. 15, with the aid of cylinder 2-13. In this manner, the upper lifting plate 2-6 causes all the hairpins H to move axially upwardly relative to the comb core 2-2, so as to reach a position in which they project further upwardly from the comb core. After this step, the driving plate 2-8 is rotated by actuating the motor 2-5, so as to move the clamp elements 2-15 radially inwardly to gently press the hairpins H against the radially inner end surfaces of slots 2-23. With the hairpins H clamped in this manner, the upper lifting plate 2-6 is then brought back (e.g., returned) to its lowered position (e.g., start position) adjacent to the upper end surface of the comb core 2-2, as shown in FIG. 16, while the hairpins are compelled to remain in the same position relative to the comb core 2-2. In this manner, the group of hairpins H is arranged in a position projecting upwardly from the comb core, where it can be easily picked-up and separated as a whole from the comb core for being transferred to a subsequent station where the group of hairpins are inserted into the slots of a motor stator.

The invention is also directed to a method for obtaining a group of hairpins (H) to be transferred into the slots of a motor stator as implemented by means of the above-described comb device.

Naturally, where the principle of the invention remains the same, the details of construction and the embodiment may widely vary with respect to what has been described and illustrated purely by way of example, without departing from the scope of the present invention, as defined in the appended claims.

1. A comb device, for receiving a group of hairpins to be subsequently transferred into slots of a motor stator, said comb device comprising a cylindrical comb core having a cylindrical lateral surface, two opposite end surfaces, and a circumferential array of uniformly distributed axial slots which open at two opposite ends of the axial slots, on the two opposite end surfaces of the comb core, said axial slots being configured for receiving therein a plurality of hairpins forming the group of hairpins,
wherein said axial slots of the comb core are also open radially outwardly by apertures of the lateral surface of the comb core,
wherein said comb device further comprises:
a circumferential array of clamp elements radially slidably mounted within said axial slots of the comb core through said apertures on the lateral surface of the comb core, said clamp elements being configured for clamping the plurality of hairpins within said axial slots after that all the plurality of hairpins have been positioned within said axial slots, and
a driving mechanism for simultaneously driving a radial movement of all the clamp elements within the respective axial slots of the comb core.

2. The comb device according to claim 1, wherein said driving mechanism for simultaneously driving the radial movement of all the clamp elements comprises:
a circumferential array of radial driving members, surrounding the array of clamp elements and positioned outside the comb core, each driving member being operatively connected to a respective one of said clamp elements, said driving members being radially slidably guided within radial guiding passages of a stationary annular plate;
a driving annular plate, surrounding the comb core, and rotatably mounted around a main axis of the comb core on said stationary annular plate,
said driving annular plate defining a plurality of spiral slits engaged by cam-followers which are carried by said driving members, said spiral slits being configured so that a rotation of said driving annular plate between two end positions causes a radial movement of said driving members, thereby radially moving said clamp elements between two end positions of said driving members, and
an actuator for rotating said driving annular plate between said two end positions of said driving annular plate.

3. The comb device according to claim 2, wherein said spiral slits are configured so that a rotation of the driving annular plate at a constant speed causes the radial movement of the clamp elements at a constant speed.

4. The comb device according to claim 2, wherein each spiral slit is engaged by two of the cam-followers carried by two of the driving members which are adjacent to each other, so that a number of spiral slits is half a number of the clamp elements.

5. The comb device according to claim 2, wherein each driving member is a rod-like member having one end hinged to a respective one of the clamp element and an opposite end carrying a respective one of the cam-follower.

6. The comb device according to claim 2, wherein each driving member is a rod-like member having an inverted T-shaped cross-section, and is slidably guided within a respective one of the radial guiding passage of said stationary annular plate having a corresponding T-shaped cross-section.

7. The comb device according to claim 1, wherein the comb device further comprises an upper lifting plate arranged above an upper-end surface of the two opposite end surfaces of the comb core, the upper lifting plate having a circumferential array of radial slots which correspond in a number and positions with the axial slots of the comb core, so that when hairpins of the plurality of hairpins are being axially plugged into the axial slots of the comb core, the hairpins first engage the radial slots of said upper lifting plate and then the axial slots of the comb core,
said upper lifting plate being connected to an actuator which is operable for:
once all the hairpins have been positioned into the comb core, raising said upper lifting plate from a start position adjacent the comb core to a raised position, spaced apart upwardly from the comb core, in which the upper lifting plate causes the hairpins to project further upwardly from the upper end surface of the comb core, and
subsequently returning the upper lifting plate to the start position adjacent the comb core, after that the clamp elements have been driven to clamp the hairpins within the comb core, so that the hairpins remain in said position projecting upwardly from the comb core in which the group of the hairpins can be picked-up and separated as a whole from the comb core.

8. The comb device according to claim 1, wherein said driving mechanism is operable for progressively moving the clamp elements radially outwardly while hairpins are being inserted into the axial slots of the comb core, so as to progressively leave more space along a radial direction within the axial slots for the hairpins to be positioned within the axial slots.

9. A method for obtaining a group of hairpins to be transferred into slots of a motor stator, comprising:
providing a comb device comprising a cylindrical comb core having a cylindrical lateral surface and two opposite end surfaces and a circumferential array of uniformly distributed axial slots which open at two opposite ends of the axial slots, on the two opposite end surfaces of the comb core, and
inserting a plurality of hairpins into said axial slots of the comb core,
wherein
said axial slots of the comb core are also open radially upwardly by apertures of the lateral surface of the comb core, wherein said comb device further comprises:
a circumferential array of clamp elements are radially slidably mounted within said axial slots of the comb core through said apertures on the lateral surface of the comb core;
a driving mechanism configured for simultaneously driving a radial movement of all the clamp elements within the respective axial slots of the comb core,
said method comprising an operation of actuating said driving mechanism so as to move said clamp elements within said axial slots.

10. The method according to claim 9, wherein said driving mechanism is actuated for progressively moving the clamp elements radially outwardly while hairpins of the plurality of hairpins are being inserted into the axial slots of the comb core, so as to progressively leave more space along a radial direction within the axial slots for the hairpins to be positioned within the axial slots.

11. The method according to claim 9, comprising:
providing an upper lifting plate arranged above an upper-end surface of the two opposite end surfaces of the comb core, the upper lifting plate having a circumferential array of radial slots which correspond in a number and positions with the axial slots of the comb core, so that when hairpins of the plurality of hairpin are being axially plugged into the axial slots of the comb core, the hairpins first engage the radial slots of said upper lifting plate and then the axial slots of the comb core, said upper lifting plate being connected to an actuator,
once all the hairpins have been positioned into the comb core, raising said upper lifting plate, by said actuator, from a start position adjacent the comb core to a raised position, spaced apart upwardly from the comb core, in which the upper lifting plate causes the hairpins to project further upwardly from the upper end surface of the comb core, and
subsequently returning the upper lifting plate, by said actuator to the start position adjacent the comb core, after that the clamp elements have been driven to clamp the hairpins within the comb core, so that the hairpins remain in said position projecting upwardly from the comb core in which the group of the hairpins can be picked-up and separated as a whole from the comb core.
